(19) United States
(12) Patent Application Publication
(10) Pub. No.: US 2007/0109486 A1
(43) Pub. Date: May 17, 2007

(54) LIQUID CRYSTAL DISPLAY PANEL

(76) Inventors: Li-Ping Liu, Kaohsiung City (TW); Chih-Ming Chang, Taoyuan County (TW); Meng-Chang Tsai, Chiayi City (TW); Kun-Yu Lin, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,611

(22) Filed: Apr. 12, 2006

(30) Foreign Application Priority Data
Nov. 15, 2005 (TW) 94140038

(51) Int. Cl. G02F 1/1339

(52) U.S. Cl. 349/153

(57) ABSTRACT

A liquid crystal display (LCD) panel including an active matrix substrate, an opposite substrate, a first sealant, a liquid crystal layer, an upper particle barrier and a second sealant is provided. The opposite substrate is disposed above the active matrix substrate. The first sealant is disposed between the active matrix substrate and the opposite substrate, and the LCD panel has a liquid crystal injection inlet. The liquid crystal layer is interposed between the active matrix substrate and the opposite substrate. The upper particle barrier is disposed on the opposite substrate corresponding to the liquid crystal injection inlet. The second sealant is disposed at the liquid crystal injection inlet. The upper particle barrier is adapted for preventing the particles accompanying the liquid crystals from entering the LCD panel during the liquid crystal injection process, to avoid the defects of the LCD panel due to the particles.

### CROSS-REFERENCE TO RELATED APPLICATION

This application claims the priority benefit of Taiwan application serial no. 94140038, filed on Nov. 15, 2005. All disclosure of the Taiwan application is incorporated herein by reference.

### BACKGROUND OF THE INVENTION

1. Field of the Invention

The present invention generally relates to a liquid crystal display (LCD) panel, and more particularly, to an LCD panel for preventing particles accompanying liquid crystal molecules from entering a liquid crystal layer thereof through a liquid crystal injection inlet.

2. Description of Related Art

With the advantages of high image quality, small volume, low driving voltage, low power consumption and a wide range of application, the liquid crystal display (LCD) panel has been broadly applied in consumer products to replace the conventional cathode ray tube (CRT) and become the mainstream on the market. The application of the liquid crystal display includes medium- and small-size portable television, cellular phone, camcorder, notebook computer, desktop computer, projection-type television and other computer products.

The LCD panel is composed of two matrix substrates and a liquid crystal layer interposed therebetween. Generally speaking, the liquid crystal injection process is that placing a display panel having a liquid crystal injection inlet in a chamber first, and then the chamber is pumped to vacuum. In the next step, the display panel is submerged in a container of liquid crystal, and then the chamber is pumped up to the atmospheric pressure such that liquid crystals are filled between the two substrates through the liquid crystal injection inlet by the external pressure.

FIG. 1 is a schematic, three-dimensional diagram showing a conventional liquid crystal injection process of a display panel. Referring to FIG. 1, the display panel 100, a liquid crystal layer is not formed therein, comprises a thin film transistor array substrate 112, a color filter substrate 114 and a sealant 116. The sealant 116 is formed between the thin film transistor array substrate 112 and the color filter substrate 114, and has a liquid crystal injection inlet 10.

More particularly, during the liquid crystal injection process, the liquid crystals within the container 100 are pressured and injected between the thin film transistor array substrate 112 and the color filter substrate 114 by the principle of capillarity. It should be noted that the liquid crystals injected from the liquid crystal injection inlet 10 and filled between the thin film transistor array substrate 112 and the color filter substrate 114 may be mixed up with conductive particles P. These conductive particles P may cause the abnormal electrical connection between the pixel electrodes (not shown herein) of the thin film transistor array substrate 112 and the common electrodes (not shown herein) of the color filter substrate 114. In other words, these conductive particles P may possibly cause inefficient control of the liquid crystals. Accordingly, after the liquid crystal injection process is completed, the display panel 110 may have defects such as white spots or black spots during operation.

When the cell gap between the thin film transistor array substrate 112 and the color filter substrate 114 becomes smaller, the occurrence of the abnormal electrical connection between the pixel electrode (not shown herein) of the thin film transistor array substrate 112 and the common electrode (not shown herein) of the color filter substrate 114 due to the conductive particles P accompanying the liquid crystals becomes more frequently. If the liquid crystals from the liquid crystal injection inlet 10 are accompanied by excess conductive particles P during the liquid crystal injection process, a lower display quality and fabrication yield might be brought about.

### SUMMARY OF THE INVENTION

Accordingly, one objective of the present invention is to provide a liquid crystal display (LCD) panel for preventing particles from entering a space between two substrates through a liquid crystal injection inlet during a liquid crystal injection process.

Another objective of the present invention is to provide an LCD panel of higher fabrication yield.

As embodied and broadly described herein, the present invention provides an LCD panel comprising an active matrix substrate, an opposite substrate, a first sealant, a liquid crystal layer, an upper particle barrier and a second sealant. The opposite substrate is disposed above the active matrix substrate. The first sealant is disposed between the active matrix substrate and the opposite substrate, and has a liquid crystal injection inlet. Additionally, the liquid crystal layer is interposed between the active matrix substrate and the opposite substrate. The upper particle barrier is formed on the opposite substrate and adjacent to the liquid crystal injection inlet. Furthermore, the second sealant is adjacent to the liquid crystal injection inlet, and the liquid crystal layer is sealed between the active matrix substrate and the opposite substrate by the first sealant and the second sealant.

According to an embodiment of the present invention, the LCD panel may further comprise a lower particle barrier formed on the active matrix substrate and adjacent to the liquid crystal injection inlet.

According to an embodiment of the present invention, the lower particle barrier comprises a dielectric layer and an organic material layer. The dielectric layer is disposed on the active matrix substrate. The organic material layer is disposed on the dielectric layer and has a plurality of concave portions to expose a portion of the dielectric layer.

According to an embodiment of the present invention, the lower particle barrier comprises a dielectric layer and a plurality of organic bumps. The dielectric layer is disposed on the active matrix substrate. The organic bumps are disposed on the dielectric layer.

According to an embodiment of the present invention, the lower particle barrier comprises a dielectric layer and a plurality of organic bumps. The dielectric layer has a plurality of successive concaves and convexes, and is disposed on the active matrix substrate. The organic bumps are disposed on the convexes of the dielectric layer.

According to an embodiment of the present invention, the lower particle barrier comprises a plurality of dielectric bumps and a plurality of organic bumps. The dielectric bumps are disposed on the active matrix substrate. The organic bumps are disposed on the dielectric bumps, respectively.

According to an embodiment of the present invention, the opposite substrate comprises a color filter substrate. More particularly, the color filter substrate comprises a substrate, a black matrix and a plurality of color filters. The black matrix is disposed on the substrate, and has a plurality of lattices. The color filters are disposed on the substrate and within the lattices, respectively.

According to an embodiment of the present invention, the upper particle barrier and the black matrix are made of the same materials.

According to an embodiment of the present invention, the upper particle barrier and the color filters are made of the same material.

According to an embodiment of the present invention, except for the substrate, the black matrix and the color filters, the opposite substrate may further comprise an over-coating layer formed on the black matrix and the color filters.

According to an embodiment of the present invention, the upper particle barrier and the over-coating layer are made of the same material.

According to an embodiment of the present invention, the opposite substrate may further comprise at least one black matrix and a plurality of color filters. The black matrix is disposed on a periphery of the opposite substrate and substantially surrounded by the first sealant. The color filters are disposed on the opposite substrate and substantially surrounded by the black matrix.

According to an embodiment of the present invention, the upper particle barrier and the black matrix are made of the same materials.

According to an embodiment of the present invention, the upper particle barrier and the color filters are made of the same material.

According to an embodiment of the present invention, the opposite substrate may further comprise an over-coating layer formed on the black matrix and the color filters. The upper particle barrier and the over-coating layer are made of the same material.

As embodied and broadly described herein, the present invention also provides an LCD panel comprising an active matrix substrate, an opposite substrate, a first sealant, a liquid crystal layer, a lower particle barrier and a second sealant. The active matrix substrate has an organic layer formed thereon. The opposite substrate is disposed above the active matrix substrate. Additionally, the opposite substrate is disposed above the active matrix substrate. The first sealant is disposed between the active matrix substrate and the opposite substrate, and has a liquid crystal injection inlet. Furthermore, the liquid crystal layer is interposed between the active matrix substrate and the opposite substrate. The lower particle barrier is disposed on the active matrix substrate and adjacent to the liquid crystal injection inlet, and the lower particle barrier and the organic layer are made of the same material. The second sealant is adjacent to the liquid crystal injection inlet, and the liquid crystal layer is sealed by the first sealant and the second sealant between the active matrix substrate and the opposite substrate.

According to an embodiment of the present invention, the lower particle barrier comprises a passivation layer and an organic material layer. The passivation layer is formed on the active matrix substrate. The organic material layer covers the passivation layer and has a plurality of concave portions.

According to an embodiment of the present invention, the lower particle barrier comprises a passivation layer and a plurality of organic bumps. The passivation layer is disposed on the active matrix substrate. The organic bumps are disposed on the passivation layer.

According to an embodiment of the present invention, the lower particle barrier comprises a passivation layer and a plurality of organic bumps. The passivation layer has a plurality of successive concaves and convexes, and is disposed on the active matrix substrate. The organic bumps are disposed on the convexes of the passivation layer.

According to an embodiment of the present invention, the lower particle barrier comprises a plurality of passivation bumps and a plurality of organic bumps. The passivation bumps are disposed on the active matrix substrate. The organic bumps are disposed on the passivation bumps, respectively.

According to an embodiment of the present invention, the organic layer comprises a passivation layer and an organic material layer. The organic material layer covers the passivation layer.

According to an embodiment of the present invention, the active matrix substrate further comprises a pixel electrode disposed between the passivation layer and the organic material layer.

According to an embodiment of the present invention, the active matrix substrate further comprises a pixel electrode disposed on the organic material layer.

In summary, the LCD panel of the present invention utilizes the arrangement of the upper particle barrier and/or lower particle barrier disposed at the liquid crystal injection inlet to prevent the particles accompanying the liquid crystals from entering the LCD panel through the liquid crystal injection inlet during the liquid crystal injection process. Accordingly, the fabrication yield and the display quality of the LCD panel are enhanced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic and three-dimensional diagram showing a conventional liquid crystal injection process of a display panel.

FIG. 2 is a schematic diagram showing an LCD panel according to a first embodiment of the present invention.

FIG. 2A is a schematic diagram showing an opposite substrate according to another embodiment of the present invention.

FIG. 3 is a schematic and cross-sectional view along the line A-A′ of the LCD panel illustrated in FIG. 2.

FIG. 3A is a schematic and cross-sectional view along the line B-B′ of the opposite substrate illustrated in FIG. 2A.

FIG. 4A is a schematic diagram showing an active matrix substrate and an opposite substrate having concave portions according to the first embodiment of the present invention.

FIG. 4B is a schematic diagram showing an active matrix substrate and an opposite substrate having concave portions according to the first embodiment of the present invention.

FIG. 4C is a schematic diagram showing an active matrix substrate and an opposite substrate having concave portions according to the first embodiment of the present invention.

FIG. 5 is a schematic diagram showing the arrangement of an upper particle barrier.

FIG. 6A is a schematic cross-sectional view showing an LCD panel according to a second embodiment of the present invention.

FIGS. 6B˜6D are schematic diagrams showing an active matrix substrate and an opposite substrate having concave portions with different depths according to the second embodiment of the present invention.

FIG. 7A is a schematic cross-sectional view showing an LCD panel according to a third embodiment of the present invention.

FIGS. 7B˜7D are schematic diagrams showing an active matrix substrate and an opposite substrate having concave portions with different depths according to the third embodiment of the present invention.

FIG. 8 is a schematic diagram showing an LCD panel according to one embodiment of the present invention.

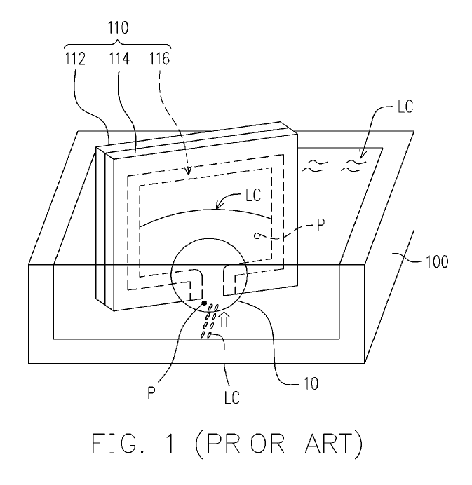

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

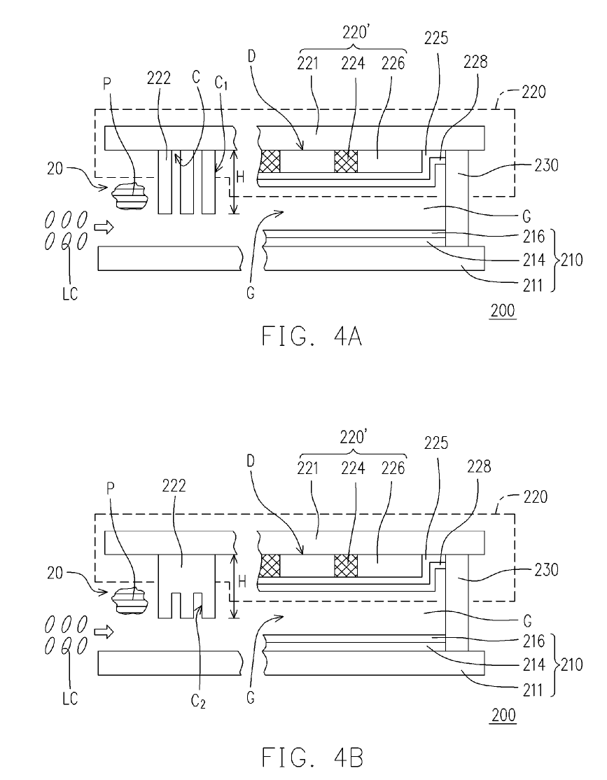

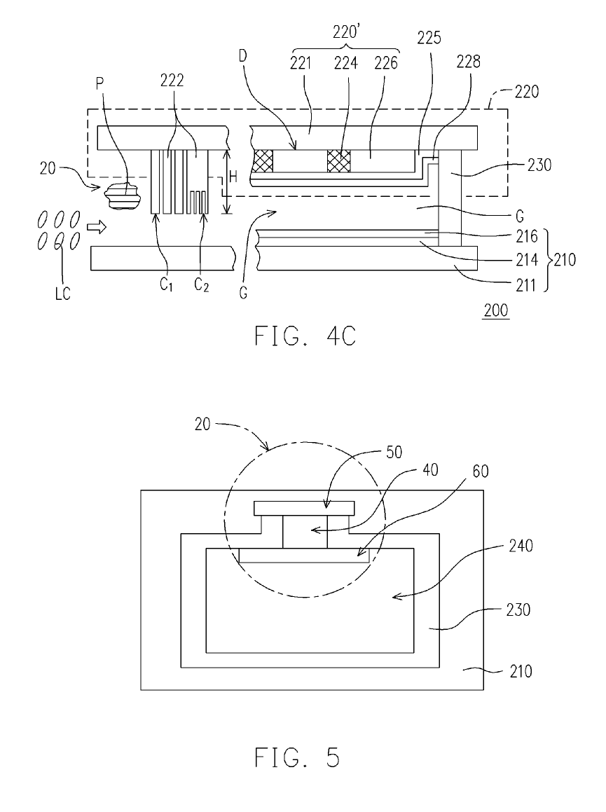

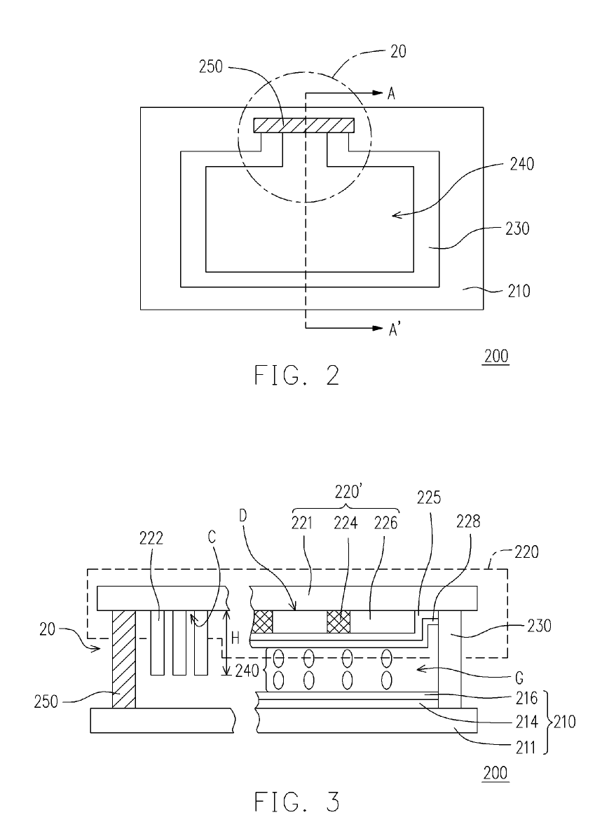

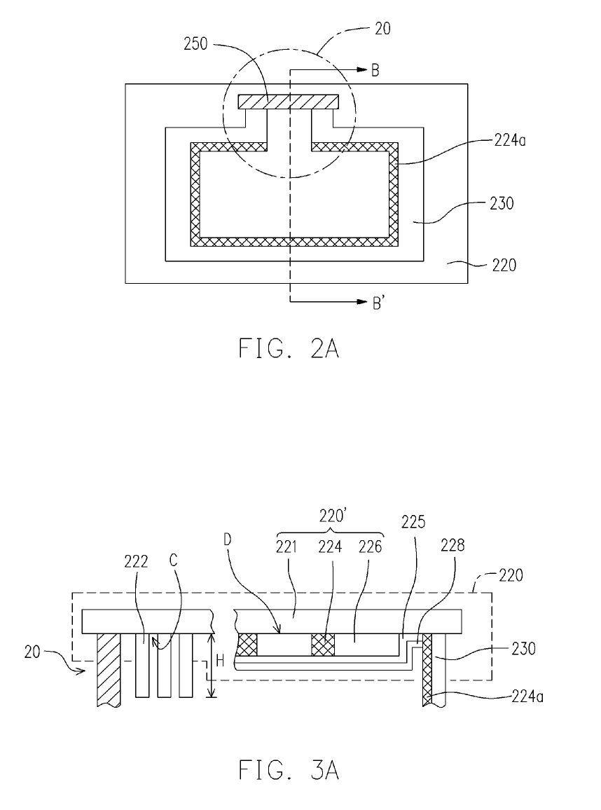

FIG. 2 is a schematic diagram showing an LCD panel according to a first embodiment of the present invention. FIG. 3 is a schematic and cross-sectional view along the line A-A′ of the LCD panel illustrated in FIG. 2. Referring to FIGS. 2 and 3, an LCD panel 200 of the present invention comprises an active matrix substrate 210, an opposite substrate 220, a first sealant 230, a liquid crystal layer 240, an upper particle barrier 222 and a second sealant 250. Generally speaking, the active matrix substrate 210 comprises a substrate 211, a plurality of scan lines (not shown herein) and a plurality of data lines (not shown herein) on the substrate 211, a plurality of thin film transistors (not shown herein), a passivation layer 214 covering the thin film transistors and a pixel electrode 216 electrically connected to the thin film transistor. Additionally, an organic layer (not shown herein) can be selectively disposed on the pixel electrode 216 or between the passivation layer 214 and the pixel electrode 216 so that it is adapted for different kinds of LCD panels such as the transmissive LCD, the reflective LCD or the transflective LCD.

Referring to FIG. 3, it is clear that the opposite substrate 220 is disposed above the active matrix substrate 210, and the opposite substrate 220 can be a color filter substrate 220′. More specifically, the color filter substrate 220′ comprises a substrate 221, a black matrix 224 and a plurality of color filters 226. The black matrix 224 is disposed on the substrate 221 and is adapted for defining a plurality of lattices D. The color filters 226 are disposed on the substrate 221 and within the lattices D, respectively. The color filters 226 can be made of red resin, blue resin or green resin. The black matrix 224 can be made of alternatively stacked red resin, blue resin and green resin, or a material which is not pervious to light such as metal (Cr), resin or composite films of metal and resin. Generally, the opposite substrate 220 further comprises a common electrode 228 disposed on the black matrix 224 and the color filters 226.

As shown in FIG. 3, the first sealant 230 is disposed between the active matrix substrate 210 and the opposite substrate 220, and the LCD panel 200 further includes a liquid crystal injection inlet 20. More particularly, a space G for containing the liquid crystals is defined by the first sealant 230, the active matrix substrate 210 and the opposite substrate 220, and the liquid crystals are injected into the space G in order to form a liquid crystal layer 240. In other words, the liquid crystal layer 240 is interposed between the pixel electrode 216 of the active matrix substrate 210 and the common electrode 228 of the opposite substrate 220.

It should be noted that the upper particle barrier 222 is formed on the opposite substrate 220 and adjacent to the liquid crystal injection inlet 20. Referring FIG. 3, it is clear that the upper particle barrier 222 at least includes one concave portion C such that the substrate 221 of the opposite substrate 220 is exposed by the concave portion C of the upper particle barrier 222.

Additionally, the second sealant 250 is disposed adjacent to the liquid crystal injection inlet 20, and the liquid crystal layer 240 is sealed between the active matrix substrate 210 and the opposite substrate 220 by the first sealant 230 and the second sealant 250. In this embodiment, a material of the first sealant 230 and the second sealant 250 comprises a thermal curing compound or an UV curing compound. A material of the upper particle barrier 222 can be the same as that of the black matrix 224 or color filters 226. In other words, the upper particle barrier 222 and the black matrix 224 or the color filters 226 can be fabricated at the same time.

In one embodiment of the present invention, the opposite substrate 220 may further comprise an over-coating layer 225 formed on the black matrix 224 and the color filters 226, and the common electrode 228 is disposed on the over-coating layer 225. It should be noted that the upper particle barrier 222, the black matrix 224, and the color filters 226 or the over-coating layer 225 can use the same materials. In other words, the upper particle barrier 222 and the black matrix 224, the color filters 226 or the over-coating layer 225 can be fabricated at the same time.

Referring to FIGS. 2A and 3A, another embodiment of the present invention, a black matrix 224a can be disposed on the periphery of the opposite substrate 220 and substantially surrounded by the first sealant 230. The black matrix 224a adjacent to the first sealant 230 is adapted for preventing light leakage of the LCD panel 200 during operation. Additionally, a plurality of color filters 226 (as shown in FIG. 3A) are disposed on the opposite substrate 220 and within the region defined by the black matrix 224a. It should be noted that a material of the upper particle barrier 222, the black matrix 224a or the color filters 226 can use the same materials. Referring to FIG. 3A, it is clear that the opposite substrate 220 of the present invention further comprises an over-coating layer 225 formed on the black matrix 224a and the color filters 226, and the common electrode 228 covering the over-coating layer 225.

The method of forming the liquid crystal layer 240 in the LCD panel 200 is to place the LCD panel 200, in which the liquid crystals are not injected and the liquid crystal injection inlet 20 thereof is not sealed (i.e. the second sealant 250 is not formed), in a chamber (not shown herein). In the following step, the chamber is pumped to neat vacuum and, then the LCD panel 200, in which the liquid crystal layer 240 is not formed and the liquid crystal injection inlet 20 is not sealed, is immersed in the liquid crystals LC within the chamber. In the next step, the chamber is pumped up to the atmospheric pressure such that the liquid crystals are pressured and injected into the space G by the principle of capillarity, to form the liquid crystal layer 240.

FIG. 4A is a schematic diagram showing an active matrix substrate and an opposite substrate having concave portions according to the first embodiment of the present invention. Referring to FIG. 4A, before the liquid crystals are injected into the space G, the liquid crystal injection inlet 20 is not sealed by the second sealant 250 (as shown in FIG. 3), but the liquid crystals are not injected into the space G through the liquid crystal injection inlet 20. When the liquid crystals flow through the liquid crystal injection inlet 20, the upper particle barrier 222 could produce a turbulent flow. The upper particle barrier 222 can stop the particles P accompanying the liquid crystals LC from entering the space G. After the liquid crystal injection process is completed, the liquid crystal injection inlet 20 is sealed by the second sealant 250.

Referring to FIG. 4A, it is clear that the upper particle barrier 222 includes a plurality of columns C1, and the upper particle barrier 222 may have other shapes as required. In another embodiment of the present invention, the upper particle barrier 222 may have a plurality of grooves C2 (as shown in FIG. 4B). Additionally, the upper particle barrier 222 may comprise the combination of the columns C1 and the grooves C2 (as shown in FIG. 4C). The shape of the upper particle barrier 222 is not limited in the present invention.

It should be noted that the height H of the upper particle barrier 222 can be adjusted in accordance with the size of the liquid crystals or the gap between the active matrix substrate 210 and the opposite substrate 220, such that the liquid crystals can be injected into the space G smoothly and the particles P can be stopped by the upper particle barrier 222. Compared with the prior art, the arrangement of the upper particle barrier 222 can prevent the particles P from entering the space G and being disposed on the display region (not shown herein) near the liquid crystal injection inlet 20, such that the abnormal electrical connection between the pixel electrode 216 of the active matrix substrate 210 and the common electrode 228 of the opposite substrate 220 would not occur, and further the problems of white spots/black spots can be prevented. The arrangement of the upper particle barrier 222 can lower the occurrence rate of the above-mentioned problems by 90 percent approximately.

More particularly, the arrangement of the upper particle barrier 222 adjacent to the liquid crystal injection inlet 200 can be shown as the region 40, the region 50, the region 60 or combinations thereof. The shape and the size of the upper particle barrier 222 are not limited in the present invention.

In accordance with the foregoing description, the upper particle barrier 222 adjacent to the liquid crystal injection inlet 20 has the function of stopping the particles P during the liquid crystal injection process. Therefore, the abnormal electrical connection between the pixel electrode 216 of the active matrix substrate 210 and the common electrode 228 of the opposite substrate 230 is avoided, and further the defects (white spots or black spots) during operation would not occur. Therefore, the LCD panel 200 of the present invention may lower the occurrence of defects during operation efficiently, and further improve the display quality of the LCD panel. In other words, the LCD panel 200 of the present invention has a higher fabrication yield.

### Second Embodiment

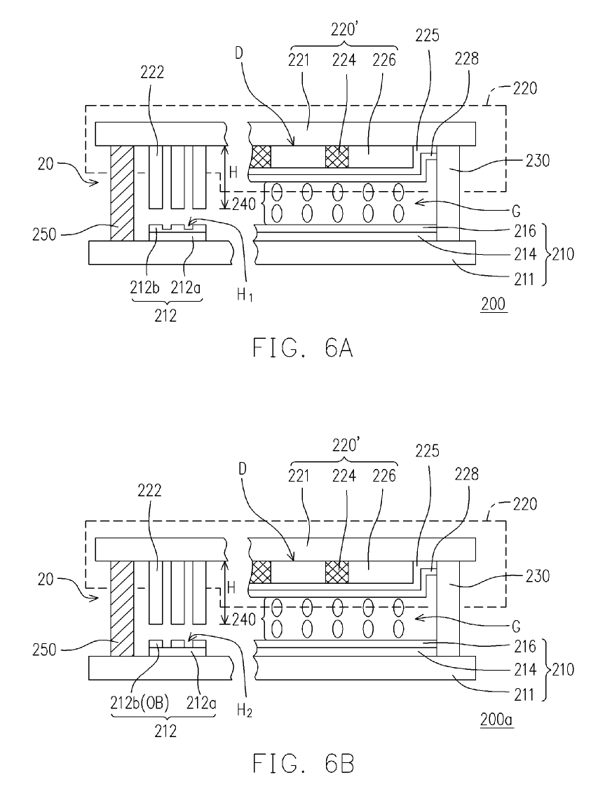

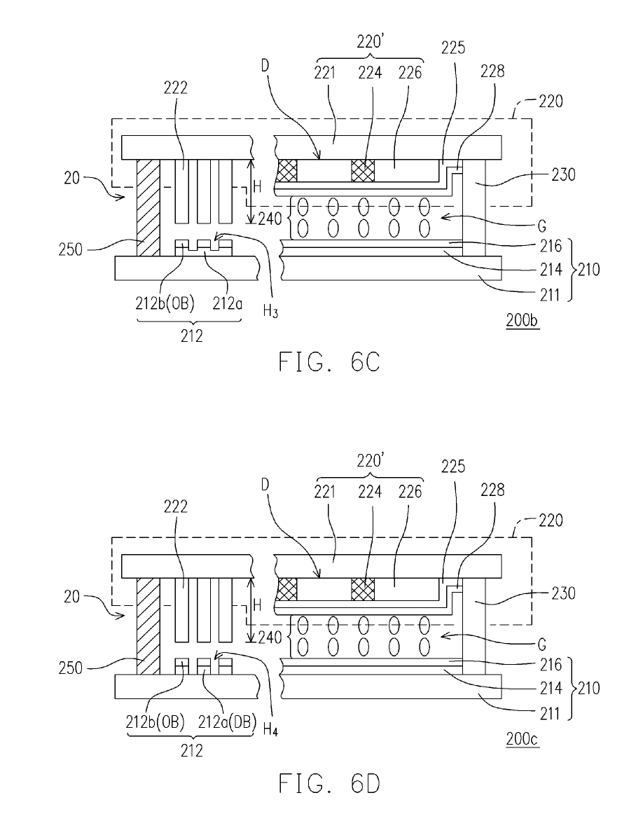

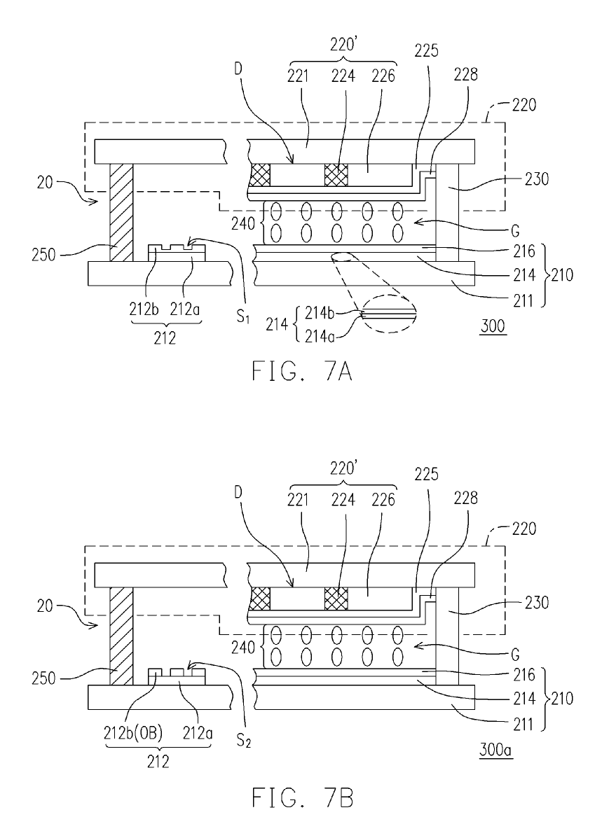

FIG. 6A is a schematic cross-sectional view showing an LCD panel according to a second embodiment of the present invention. Referring to FIG. 6A, this embodiment is similar to the first embodiment, and the difference between them lies in that a lower particle barrier 212 is formed on the active matrix substrate 210 in this embodiment. The lower particle barrier 212 is disposed on the active matrix substrate 210 and below the upper particle barrier 222.

More particularly, the lower particle barrier 212 comprises a dielectric layer 212a and an organic material layer 212b, and has a plurality of concave portions H1. The organic material layer 212b is disposed on the dielectric layer 212a, and the concave portions H1 are formed in the organic material layer 212b. More particularly, an organic layer (not shown herein) can be disposed on the pixel electrode 216 of the display region, between the passivation layer 214 and the pixel electrode 216, or between the passivation layer 214 and the substrate 211. The organic layer and the organic material layer 212b can be fabricated at the same time; however the fabrication process of the organic layer is not limited in the present invention. In addition, the depth of the concave portions H1 is not limited in the present invention. The concave portions having different depths are illustrated in the following with accompanying drawings.

Referring to FIG. 6B, the dielectric layer 212a is exposed by the concave portions H2 of the dielectric layer 212a. In other words, the dielectric layer 212a is disposed on the active matrix substrate 210, and a plurality of organic bumps OB are disposed on the dielectric layer 212a.

Next, referring to FIG. 6C, the concave portions H3 are formed in the organic material layer 212b and the dielectric layer 212a in another embodiment. In other words, the dielectric layer 212a has a pattern of a plurality of successive concaves and convexes, and the organic bumps OB are disposed on the convexes of the dielectric layer 212a. On the other hand, the organic material layer 212b having concave portions H3 may completely cover the dielectric layer 212a but not expose the dielectric layer 212a (not shown).

As shown in FIG. 6D, the substrate 211 is exposed by the concave portions H4 of the dielectric layer 212a and the organic material layer 212b. In other words, a plurality of dielectric bumps DB are disposed on the active matrix substrate 210, and a plurality of organic bumps OB are disposed on the dielectric bumps OB, respectively. It should be noted that the lower particle barrier 212 and the upper particle barrier 222 have the same functions, and the shape of the lower particle barrier 212 and the upper particle barrier 222 is not limited in the present invention.

### Third Embodiment

This embodiment is similar to the first embodiment, and the difference between them is that the LCD panel 300 only comprises the lower particle barrier 212 formed on the substrate 211 only.

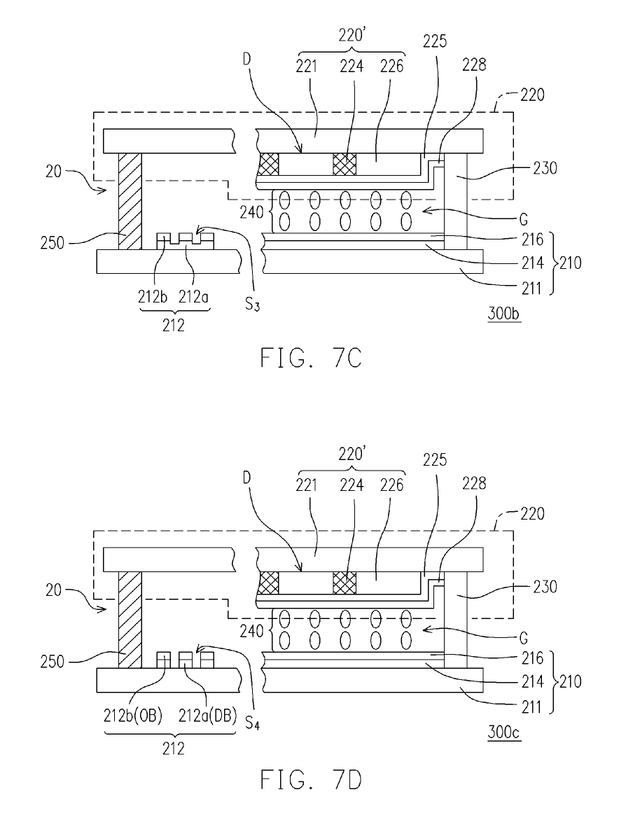

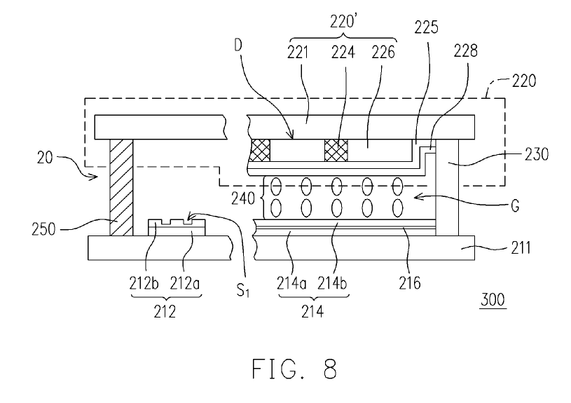

FIG. 7A is a schematic diagram showing an LCD panel according to a third embodiment of the present invention. Referring to FIG. 7A, an LCD panel 300 of the present invention comprises an active matrix substrate 210, an opposite substrate 220, a first sealant 230, a liquid crystal layer 240, a lower particle barrier 212 and a second sealant 250. The active matrix substrate 210 comprises an organic layer 214, and the organic layer 214 may comprise a passivation layer 214a and an organic material layer 214b. Generally speaking, the active matrix substrate 210 comprises a substrate 211, a plurality of scan lines (not shown herein) and a plurality of data lines (not shown herein) on the substrate 211, a plurality of thin film transistors (not shown), and a pixel electrode 216 disposed on the organic layer 214 and electrically connected to the thin film transistor. The pixel electrode 216 (as shown in FIG. 8) of the active matrix substrate 210 can be disposed between the passivation layer 214a and the organic material layer 214b, so that it is adapted for different kinds of LCD panels such as the transmissive LCD, the reflective LCD or the transflective LCD.

Referring to FIG. 7A, it is clear that the opposite substrate 220 is disposed above the active matrix substrate 210, and the opposite substrate 220 can be a color filter substrate 220′. More particularly, the color filter substrate 220′ comprises a substrate 221, a black matrix 224 and a plurality of color filters 226. The black matrix 224 is disposed on the substrate 221 and is adapted for defining a plurality of lattices D. The color filters 226 are disposed on the substrate 221 and within the lattices D, respectively. Generally, the opposite substrate 220 may further comprise a common electrode 228 disposed on the black matrix 224 and the color filters 226 corresponding to the pixel electrode 216.

In addition, the first sealant 230 is disposed between the active matrix substrate 210 and the opposite substrate 220, and the LCD panel 300 further has a liquid crystal injection inlet 20. More particularly, a space G containing the liquid crystals is defined by the first sealant 230, the active matrix substrate 210 and the opposite substrate 220, and the liquid crystals are injected into the space G in sequence to form the liquid crystal layer 240. The liquid crystal layer 240 is interposed between the pixel electrode 216 of the active matrix substrate 210 and the common electrode 228 of the opposite substrate 220.

It should be noted the lower particle barrier 212 is formed on the substrate 211 corresponding to the liquid crystal injection inlet 20. The lower particle barrier 212 and the organic layer 214 can use the same materials. In other words, the lower particle barrier 212 and the organic layer 214 covering the thin film transistor (not shown herein) can be fabricated at the same time.

More specifically, the lower particle barrier 212 comprises a dielectric layer 212a and an organic material layer 212b, and has a plurality of concave portions S1. The organic material layer 212b is disposed on the dielectric layer 212a, and the concave portions S1 are formed in the organic material layer 212b. However, the depth of the concave portions S1 is not limited in the present invention. The concave portions having different depths are illustrated in the following with accompanying drawings.

Referring to FIG. 7B, the organic material layer 212b is exposed by the concave portions S2 of the dielectric layer 212a. In other words, the dielectric layer 212a is formed on the active matrix substrate 210, and the organic material layer 212b covers the dielectric layer 212a and has a plurality of concaves.

Referring to FIG. 7C, the concave portions S3 are formed in the organic material layer 212b and the dielectric layer 212a in another embodiment. In other words, the dielectric layer 212a has a pattern of a plurality of successive concaves and convexes, and the organic bumps OB are disposed on the convexes of the dielectric layer 212a. On the other hand, the organic material layer 212b having concave portions S3 may completely cover the dielectric layer 212a but not expose the dielectric layer 212a (not shown).

Next, as shown in FIG. 7D, the substrate 211 is exposed by the concave portions S4 of the dielectric layer 212a and the organic material layer 212b. In other words, a plurality of dielectric bumps DB are disposed on the active matrix substrate 210, and a plurality of organic bumps OB are disposed on the dielectric bumps OB, respectively.

Referring to FIG. 7A, the second sealant 250 is disposed adjacent to the liquid crystal injection inlet 200, and the liquid crystal layer 240 is sealed between the active matrix substrate 210 and the opposite substrate 220 by the first sealant 230 and the second sealant 250.

In summary, the LCD panel of the present invention has the following advantages:

1. The LCD panel of the present invention makes use of the upper particle barrier and/or lower particle barrier to prevent the particles accompanying the liquid crystals from entering the LCD panel through the liquid crystal injection inlet during the liquid crystal injection process. Therefore, this design can lower the defects (white spot or black spot) of the LCD panel due to the particles and further improve the display quality of the LCD panel.

2. When the liquid crystals flow through the liquid crystal injection inlet, the upper particle barrier and/or lower particle barrier could produce a turbulent flow to stop the particles accompanying the liquid crystals. Thus, the LCD panel of the present invention has a higher fabrication yield.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel, comprising:
an active matrix substrate;
an opposite substrate disposed above the active matrix substrate;
a first sealant disposed between the active matrix substrate and the opposite substrate, wherein the first sealant has a liquid crystal injection inlet;
a liquid crystal layer interposed between the active matrix substrate and the opposite substrate;
an upper particle barrier formed on the opposite substrate and adjacent to the liquid crystal injection inlet; and
a second sealant adjacent to the liquid crystal injection inlet, wherein the liquid crystal layer is sealed between the active matrix substrate and the opposite substrate by the first sealant and the second sealant.

2. The liquid crystal display panel according to claim 1, further comprising a lower particle barrier formed on the active matrix substrate and adjacent to the liquid crystal injection inlet.

3. The liquid crystal display panel according to claim 2, wherein the lower particle barrier comprises:
a dielectric layer disposed on the active matrix substrate; and
an organic material layer disposed on the dielectric layer and having a plurality of concave portions.

4. The liquid crystal display panel according to claim 2, wherein the lower particle barrier comprises:
a dielectric layer disposed on the active matrix substrate; and
a plurality of organic bumps disposed on the dielectric layer.

5. The liquid crystal display panel according to claim 2, wherein the lower particle barrier comprises:
a dielectric layer having a plurality of successive concaves and convexes and disposed on the active matrix substrate; and
a plurality of organic bumps disposed on the convexes of the dielectric layer.

6. The liquid crystal display panel according to claim 1, wherein the lower particle barrier comprises:
a plurality of dielectric bumps disposed on the active matrix substrate; and
a plurality of organic bumps disposed on the dielectric bumps.

7. The liquid crystal display panel according to claim 1, wherein the opposite substrate comprises:
a substrate;
a black matrix disposed on the substrate, wherein the black matrix has a plurality of lattices; and
a plurality of color filters disposed on the substrate and within the lattices, respectively.

8. The liquid crystal display panel according to claim 7, wherein the upper particle barrier and the black matrix are made of the same material.

9. The liquid crystal display panel according to claim 7, wherein the upper particle barrier and the color filters are made of the same material.

10. The liquid crystal display panel according to claim 7, wherein the opposite substrate further comprises an over-coating layer formed on the black matrix and the color filters.

11. The liquid crystal display panel according to claim 10, wherein the upper particle barrier and the over-coating layer are made of the same material.

12. The liquid crystal display panel according to claim 1, further comprising:
at least one black matrix disposed on a periphery of the opposite substrate and substantially surrounded by the first sealant; and
a plurality of color filters disposed on the opposite substrate and substantially surrounded by the black matrix.

13. The liquid crystal display panel according to claim 12, wherein the upper particle barrier and the black matrix are made of the same material.

14. The liquid crystal display panel according to claim 12, wherein the upper particle barrier and the color filters are made of the same material.

15. The liquid crystal display panel according to claim 12, further comprising an over-coating layer formed on the black matrix and the color filters.

16. The liquid crystal display panel according to claim 15, wherein the upper particle barrier and the over-coating layer are made of the same material.

17. A liquid crystal display panel, comprising:
an active matrix substrate having an organic layer formed thereon;
an opposite substrate disposed above the active matrix substrate;
a first sealant disposed between the active matrix substrate and the opposite substrate, wherein the first sealant has a liquid crystal injection inlet;
a liquid crystal layer interposed between the active matrix substrate and the opposite substrate;
a lower particle barrier disposed on the active matrix substrate and adjacent to the liquid crystal injection inlet, wherein the lower particle barrier and the organic layer are made of the same material; and
a second sealant disposed adjacent to the liquid crystal injection inlet, wherein the liquid crystal layer is sealed between the active matrix substrate and the opposite substrate by the first sealant and the second sealant.

18. The liquid crystal display panel according to claim 17, wherein the lower particle barrier comprises:
a passivation layer formed on the active matrix substrate; and
an organic material layer covering the passivation layer and having a plurality of concaves.

19. The liquid crystal display panel according to claim 17, wherein the lower particle barrier comprises:
a passivation layer formed on the active matrix substrate; and
a plurality of organic bumps disposed on the passivation layer.

20. The liquid crystal display panel according to claim 17, wherein the lower particle barrier comprises:
a passivation layer having a plurality of successive concaves and convexes and disposed on the active matrix substrate; and
a plurality of organic bumps disposed on the convexes of the passivation layer .

21. The liquid crystal display panel according to claim 17, wherein the lower particle barrier comprises:
a plurality of passivation bumps disposed on the active matrix substrate; and
a plurality of organic bumps disposed on the dielectric bumps.

22. The liquid crystal display panel according to claim 17, wherein the lower particle barrier comprises:
a passivation layer formed on the active matrix substrate; and
an organic material layer covering the passivation layer.

23. The liquid crystal display panel according to claim 22, wherein the active matrix substrate further comprises a pixel electrode disposed between the passivation layer and the organic material layer.

24. The liquid crystal display panel according to claim 22, wherein the active matrix substrate further comprises a pixel electrode disposed on the organic material layer.
